(19) United States
(12) Patent Application Publication
(10) Pub. No.: US 2009/0284758 A1
(43) Pub. Date: Nov. 19, 2009

(54) Displacement measuring method, displacement measuring apparatus and displacement measuring target

(75) Inventor: Akira Kuwata, Osaka (JP)

Correspondence Address: BACON & THOMAS, PLLC, 625 SLATERS LANE, FOURTH FLOOR, ALEXANDRIA, VA, 22314-1176, US

(73) Assignees: Toyonaka Kenkyusho Co., Ltd., Osaka (JP); Jibanshikenjo Co., Ltd., Tokyo (JP); Pile Dynamics, Inc., Cleveland, OH (US)

(21) Appl. No.: 12/153,387

(22) Filed: May 19, 2008

(51) Int. Cl. G01B 11/14; G06F 15/00

(52) U.S. Cl. 356/614; 702/155

(57) ABSTRACT

Displacement of a subject is measured easily and accurately from a distant point by attaching a displacement measuring target, where two or four light sources are fixed on a flat, substrate to a measured point of the subject, comprehending displacement correction coefficients (Kx, Ky) expressing a relation between intervals in X and Y directions on the subject and interval detecting voltages corresponding to the intervals on the basis of position detecting voltages corresponding to positions of the light sources obtained by projecting the light from the respective light sources onto a PSD light receiving surface of a PSD camera, detecting displacement of the light source caused by displacement of the subject by the light receiving surface to output the position detecting voltage, and computing a two-dimensional or three-dimensional displacement amount of the measured point on the basis of the position detecting voltages and the displacement correction coefficients (Kx, Ky).

### BACKGROUND OF THE INVENTION

1. Field of the Invention

The present invention relates to a displacement measuring method for measuring an amount of two-dimensional or three-dimensional displacement (distance and length of displacement, and angle of displacement) of various displacement measured subject (also called as “subject” for short), for example, a displacement such as a subsidence, a protrusion, a tilt and the like of a ground, a house and a building, a deflection displacement of a bank, a road, a track and a bridge, a deformation of a wall surface of a tunnel, an oscillation of a bridge, a motion of each of body portions, and the like from a measuring spot which is away from the displacement measured subject by using a semiconductor position detecting element (a position sensitive detector: abbreviated name “PSD”), a displacement measuring apparatus for measuring an amount of displacement by the displacement measuring method, and a displacement measuring target which is used for the displacement measuring method and apparatus.

2. Description of the Conventional Art

Conventionally, as a method and apparatus for detecting and measuring an amount of displacement of various displaced subjects as mentioned above from a position which is away from the subject, there has been proposed a structure for detecting and measuring an amount of displacement of a measured point selected on a displacement measured subject so as to measure the amount of displacement of the displacement measured subject, by arranging a light emitting diode (abbreviated name “LED”) light source at the measured point so as to turn it on, and focusing and irradiating a light from the LED light source onto a light receiving surface of a PSD camera (called as “PSD light receiving surface” for short) through a lens of the PSD camera so as to form a light source image, on the basis of a position detecting voltage generated in correspondence to a position on the PSD light receiving surface of the light source image. This structure is shown, for example, in Japanese Unexamined Patent Publication No. 2000-201922, Japanese Unexamined Patent Publication No. 2004-251678 and the like.

However, in the conventional displacement measuring method and apparatus as mentioned above, since the light generated from the light source is constituted by a diffusing light, it is necessary to narrow down the light from the light source through the lens of the PSD camera so as to focus and irradiate onto one point of the PSD light receiving surface and form the light source image. Accordingly, a fixed distance and length (an amount of displacement) on the displacement measured subject are seized by the PSD light receiving surface in the state of being optically contracted or expanded by the lens, and are measured as a different amount of displacement from a true amount of displacement. In other words, if the conventional displacement measuring method and apparatus as mentioned above is used without adding any particular calibrating means, a measured value of the amount of displacement of the displacement measured subject is changed in accordance with a magnification of the optical system of the PSD camera, and a difference of distance between the displacement measured subject and the lens, and there is a risk that it is impossible to accurately measure the amount of displacement of the displacement measured subject generated actually at a high precision.

### SUMMARY OF THE INVENTION

Problem to be Solved by the Invention This invention improves such objection in the conventional displacement measuring method and apparatus as mentioned above, and makes it possible to measure a two-dimensional or three-dimensional amount of displacement generated in the displacement measured subject including a tilting displacement (a rotational displacement) from a measuring point which is away from the displacement measured subject extremely easily and at a high precision.

### Means for Solving the Problem

In order to solve the problem mentioned above, in accordance with this invention, there is employed a displacement measuring target structured such that two light sources, in which an X-direction interval and a Y-direction interval of rectangular X-Y coordinate axes are respectively kept at a predetermined X-direction interval and a predetermined Y-direction interval, are arranged and fixed on a flat plate piece shaped substrate attached to a measured point of the displacement measured subject. Further, in accordance with this invention, there is employed a displacement measuring target structured such that four light sources, in which an interval between the light sources adjacent in the X direction of the rectangular X-Y coordinate axes and an interval between the light sources adjacent in the Y direction of the rectangular X-Y coordinate axes are respectively kept at a predetermined X-direction interval and a predetermined Y-direction interval, are arranged and fixed on the flat plate piece shaped substrate attached to the measured point of the displacement measured Further, in order to solve the problem mentioned above, in accordance with this invention, there is provided a displacement measuring method that measuring is made by attaching the displacement measuring target provided with two or four light sources to a measured point of a displacement measured subject, switching lighting of each of the light sources on the displacement measuring target so as to focus and project a light from each of the light sources onto a PSD light receiving surface of a PSD camera through a lens of the PSD camera, thereby outputting an X-direction position detecting voltage and a Y-direction position detecting voltage respectively corresponding to positions on the PSD light receiving surfaces of the light sources, calculating and comprehending a rate of the predetermined X-direction interval with respect to a predetermined X-direction interval detecting voltage corresponding to the predetermined X-direction interval, that is, an X-direction displacement correction coefficient Kx and a rate of the predetermined Y-direction interval with respect to a predetermined Y-direction interval detecting voltage corresponding to the predetermined Y-direction interval, that is, a Y-direction displacement correction coefficient Ky on the basis of the X-direction position detecting voltage, the Y-direction position detecting voltage, the predetermined X-direction interval and the predetermined Y-direction interval, then measuring the X-direction position detecting voltage and the Y-direction position detecting voltage at an initial time point t₀ before displacement of each of the light sources on the displacement measured subject, and the X-direction position detecting voltage and the Y-direction position detecting voltage at a time point t₁ after displacement of each of the light sources, and computing a two-dimensional or/and three-dimensional amount of displacement of the measured point of the displacement measured subject on the basis of the X-direction position detecting voltage and the Y-direction position detecting voltage at the initial time point t₀ before displacement of each of the light sources, the X-direction position detecting voltage and the Y-direction position detecting voltage at the time point t₁ after displacement, the X-direction displacement correction coefficient Kx and the Y-direction displacement correction coefficient Ky. In this connection, the X-direction displacement correction coefficient Kx means an amount of displacement (a distance or a length) in the X direction on the displacement measured subject, corresponding to the X-direction displacement detecting voltage per unit voltage introduced as a difference of voltage between the X-direction position detecting voltage of each of the light sources obtained by the PSD camera at the time point t₁ after displacement and the X-direction position detecting voltage obtained by the PSD camera at the initial time point t₀ before displacement. In the same manner, the Y-direction displacement correction coefficient Ky means an amount of displacement (a distance or a length) in the Y direction on the displacement measured subject, corresponding to the Y-direction displacement detecting voltage per unit voltage introduced as a difference of voltage between the Y-direction position detecting voltage of each of the light sources obtained by the PSD camera at the time point t₁ after displacement and the Y-direction position detecting voltage obtained by the PSD camera at the initial time point t₀ before displacement. Further, if a measuring environment is identical between the displacement measured subject and the PSD cameral, the X-direction displacement correction coefficient Kx and the Y-direction displacement correction coefficient Ky remain unchanged. Accordingly, it is possible to measure the two-dimensional or three-dimensional amount of displacement actually generated in the displacement measured subject extremely easily and at a high precision from the measuring point which is away from the displacement measured subject, by multiplying the X-direction displacement detecting voltage value and the Y-direction displacement detecting voltage measured value which are actually measured via the PSD camera, respectively by the X-direction displacement correction coefficient Kx and the Y-direction displacement correction coefficient Ky so as to correct them.

Further, in order to execute the displacement measuring method mentioned above, in accordance with this invention, there is provided a displacement measuring apparatus comprising:

a displacement measuring target structured such that two light sources, in which an X-direction interval and a Y-direction interval of rectangular X-Y coordinate axes are respectively kept at a predetermined X-direction interval and a predetermined Y-direction interval, are arranged and fixed on a flat plate piece shaped substrate attached to a measured point of a displacement measured subject;

a PSD camera provided with a lens and a PSD light receiving surface, and outputting an X-direction position detecting voltage and a Y-direction position detecting voltage corresponding to positions on the PSD light receiving surface of the two light sources on the basis of sequential focusing and projection of a light from each of the two light sources onto the PSD light receiving surface through the lens; and

a computer computing and outputting a two-dimensional amount of displacement of a measured point of the displacement measured subject on the basis of a rate of the predetermined X-direction interval with respect to a predetermined X-direction interval detecting voltage corresponding to the predetermined X-direction interval, that is, an X-direction displacement correction coefficient Kx, and a rate of the predetermined Y-direction interval with respect to a predetermined Y-direction interval detecting voltage corresponding to the predetermined Y-direction interval, that is, a Y-direction displacement correction coefficient Ky, which are calculated on the basis of the X-direction position detecting voltage and the Y-direction position detecting voltage, and the predetermined X-direction interval and the predetermined Y-direction interval, and the X-direction position detecting voltage and the Y-direction position detecting voltage at an initial time point t₀ before displacement of the two light sources on the displacement measured subject, and the X-direction position detecting voltage and the Y-direction position detecting voltage at a time point t₁ after displacement of the two light sources on the displacement measured subject, and the X-direction displacement correction coefficient Kx and the Y-direction displacement correction coefficient Ky.

Further, in order to execute the displacement measuring method mentioned above, in accordance with this invention, there is provided a displacement measuring apparatus comprising:

a displacement measuring target structured such that four light sources, in which an X-direction interval between the light sources adjacent in an X direction of rectangular X-Y coordinate axes and a Y-direction interval between the light sources adjacent in a Y direction of the rectangular X-Y coordinate axes are respectively kept at a predetermined X-direction interval and a predetermined Y-direction interval, are arranged and fixed on a flat plate piece shaped substrate attached to a measured point of a displacement measured subject;

a PSD camera provided with a lens and a PSD light receiving surface, and outputting an X-direction position detecting voltage and a Y-direction position detecting voltage corresponding to positions on the PSD light receiving surface of the four light sources on the basis of a sequential focusing and projection of a light from each of the four light sources onto the PSD light receiving surface through the lens; and

a computer computing and outputting a two-dimensional and/or three-dimensional amount of displacement of a measured point of the displacement measured subject on the basis of a rate of the predetermined X-direction interval with respect to a predetermined X-direction interval detecting voltage corresponding to the predetermined X-direction interval, that is, an X-direction displacement correction coefficient Kx and a rate of the predetermined Y-direction interval with respect to a predetermined Y-direction interval detecting voltage corresponding to the predetermined Y-direction interval, that is, a Y-direction displacement correction coefficient Ky, which are calculated on the basis of the X-direction position detecting voltage and the Y-direction position detecting voltage, and the predetermined X-direction interval and the predetermined Y-direction interval, and the X-direction position detecting voltage and the Y-direction position detecting voltage at an initial time point t₀ before displacement of the four light sources on the displacement measured subject, and the X-direction position detecting voltage and the Y-direction position detecting voltage at a time point t₁ after displacement of the four light sources on the displacement measured subject, and the X-direction displacement correction coefficient Kx and the Y-direction displacement correction coefficient Ky.

### EFFECT OF THE INVENTION

When the displacement measuring method in accordance with this invention is executed by using the displacement measuring apparatus including the displacement measuring target in accordance with this invention, it is possible to measure extremely easily and at a high precision the two-dimensional or three dimensional amount of displacement of the various displacement measured subject such as a subsidence, a protrusion, a tilt of a ground and a building, a deflection of a bank, a road, a track and a bridge, a deformation of a wall surface of a tunnel, an oscillation of a bridge, and the like from the measuring spot which is away from the displacement measured subject in the state of non-contact with the displacement measured subject, on the basis of an extremely simple measuring operation achieved by orienting the PSD camera to the light source on the displacement measuring target attached to the displacement measured subject so as to image the light source.

### BEST MODE FOR CARRYING OUT THE INVENTION

In accordance with one of best modes for carrying out this invention, there is provided a displacement measuring method that measuring is made by attaching a displacement measuring target structured such that four light sources, in which an X-direction interval between the light sources adjacent in an X direction of rectangular X-Y coordinate axes and a Y-direction interval between the light sources adjacent in a Y direction of the rectangular X-Y coordinate axes are respectively kept at a predetermined X-direction interval Sx and a predetermined Y-direction interval Sy, are arranged and fixed on a flat plate piece shaped substrate, to a measured point of a displacement measured subject, switching lighting of each of the four light sources so as to focus and project a light from each of the light sources onto a PSD light receiving surface of a PSD camera through a lens of the PSD camera, thereby outputting an X-direction position detecting voltage and a Y-direction position detecting voltage respectively corresponding to positions on the PSD light receiving surfaces of the four light sources, calculating and comprehending a rate of the predetermined X-direction interval Sx with respect to a predetermined X-direction interval detecting voltage Vsx corresponding to the predetermined X-direction interval Sx, that is, an X-direction displacement correction coefficient Kx and a rate of the predetermined Y-direction interval with respect to a predetermined Y-direction interval detecting voltage Vsy corresponding to the predetermined Y-direction interval Sy, that is, a Y-direction displacement correction coefficient Ky on the basis of the X-direction position detecting voltage, the Y-direction position detecting voltage, the predetermined X-direction interval Sx and the predetermined Y-direction interval Sy, then measuring the X-direction position detecting voltage and the Y-direction position detecting voltage at an initial time point t₀ before displacement of each of the four light sources on the displacement measured subject, and the X-direction position detecting voltage and the Y-direction position detecting voltage at a time point t₁ after displacement of each of the four light sources, and computing a two-dimensional and/or three-dimensional amount of displacement of the measured point of the displacement measured subject on the basis of the X-direction position detecting voltage and the Y-direction position detecting voltage at the initial time point t₀ before displacement of each of the four light sources, the X-direction position detecting voltage and the Y-direction position detecting voltage at the time point t₁ after displacement, the X-direction displacement correction coefficient Kx and the Y-direction displacement correction coefficient Ky.

In accordance with another of best modes for carrying out this invention, there is provided a displacement measuring apparatus comprising:

a displacement measuring target structured such that four light sources, in which an X-direction interval between the light sources adjacent in an X direction of rectangular X-Y coordinate axes and a Y-direction interval between the light sources adjacent in a Y direction of the rectangular X-Y coordinate axes are respectively kept at a predetermined X-direction interval Sx and a predetermined Y-direction interval Sy, are arranged and fixed on a flat plate piece shaped substrate attached to a measured point of a displacement measured subject;

a PSD camera provided with a lens and a PSD light receiving surface, and outputting an X-direction position detecting voltage and a Y-direction position detecting voltage corresponding to positions on the PSD light receiving surface of the four light sources on the basis of a sequential focusing and projection of a light from each of the four light sources onto the PSD light receiving surface through the lens; and

a computer computing and outputting a two-dimensional and/or three-dimensional amount of displacement of a measured point of the displacement measured subject on the basis of a rate of the predetermined X-direction interval Sx with respect to a predetermined X-direction interval detecting voltage Vsx corresponding to the predetermined X-direction interval Sx, that is, an X-direction displacement correction coefficient Kx and a rate of the predetermined Y-direction interval Sy with respect to a predetermined Y-direction interval detecting voltage Vsy corresponding to the predetermined Y-direction interval Sy, that is, a Y-direction displacement correction coefficient Ky, which are calculated on the basis of the X-direction position detecting voltage and the Y-direction position detecting voltage, and the predetermined X-direction interval Sx and the predetermined Y-direction interval Sy, and the X-direction position detecting voltage and the Y-direction position detecting voltage at an initial time point t₀ before displacement of the four light sources on the displacement measured subject, and the X-direction position detecting voltage and the Y-direction position detecting voltage at a time point t₁ after displacement of the four light sources on the displacement measured subject, and the X-direction displacement correction coefficient Kx and the Y-direction displacement correction coefficient Ky.

Further, in the best mode for carrying out this invention, an extremely important role is played by the displacement measuring target, in which two light sources structured such that the X-direction interval and the Y-direction interval of the rectangular X-Y coordinate axes are kept respectively at the predetermined X-direction interval and the predetermined Y-direction interval are arranged and fixed on the flat plate piece shaped substrate attached to the measured point of the displacement measured subject, and the displacement measuring target, in which four light sources structured such that the interval between the light sources adjacent in the X direction of the rectangular X-Y coordinate axes and the interval between the light sources adjacent in the Y direction of the rectangular X-Y coordinate axes are kept respectively at the predetermined X-direction interval and the predetermined Y-direction interval are arranged and fixed on the flat plate piece shaped substrate attached to the measured point of the displacement measured subject.

### BRIEF EXPLANATION OF DRAWING

FIG. 1 is an explanatory view of a basic structure of the displacement measuring apparatus in accordance with this invention;

FIGS. 2(a) and 2(b) are plan views of the displacement measuring target used as a main portion of this invention;

FIG. 3 is an explanatory view of measurement of a two-dimensional parallel displacement by the displacement measuring method and apparatus in accordance with this invention;

FIGS. 4(a) and 4(b) are explanatory views of measurement of a two-dimensional rotational displacement by the displacement measuring method and apparatus in accordance with this invention;

FIGS. 5(a) and 5(b) are explanatory views of measurement of a three-dimensional displacement by the displacement measuring method and apparatus in accordance with this invention; and

FIG. 6 is a table of the relation between a light source position coordinate and a position detecting voltage in the displacement measuring method in accordance with this invention.

### DETAILED DESCRIPTION OF PREFERRED EMBODIMENT

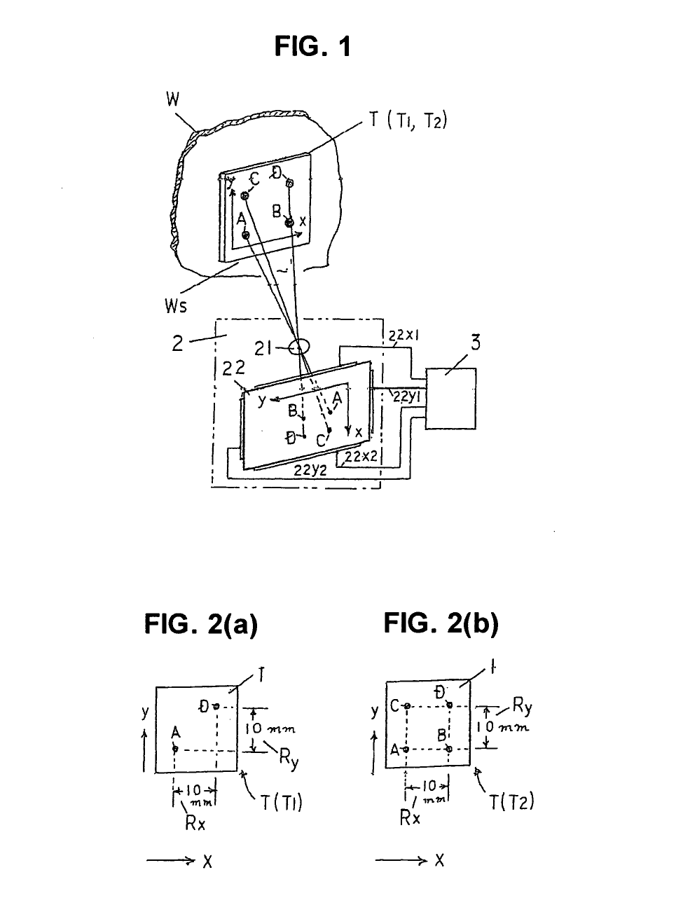

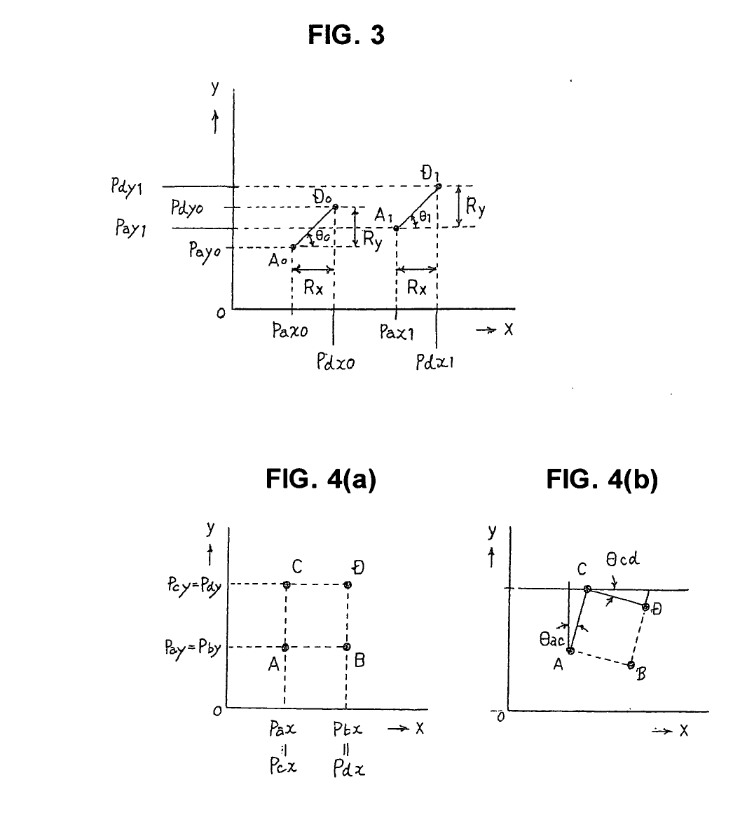

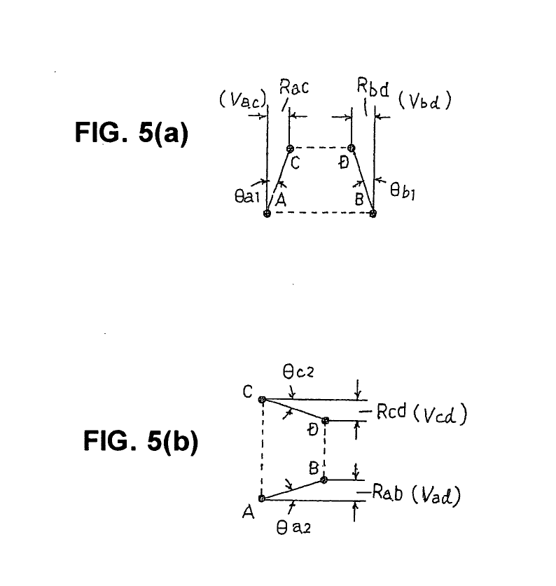

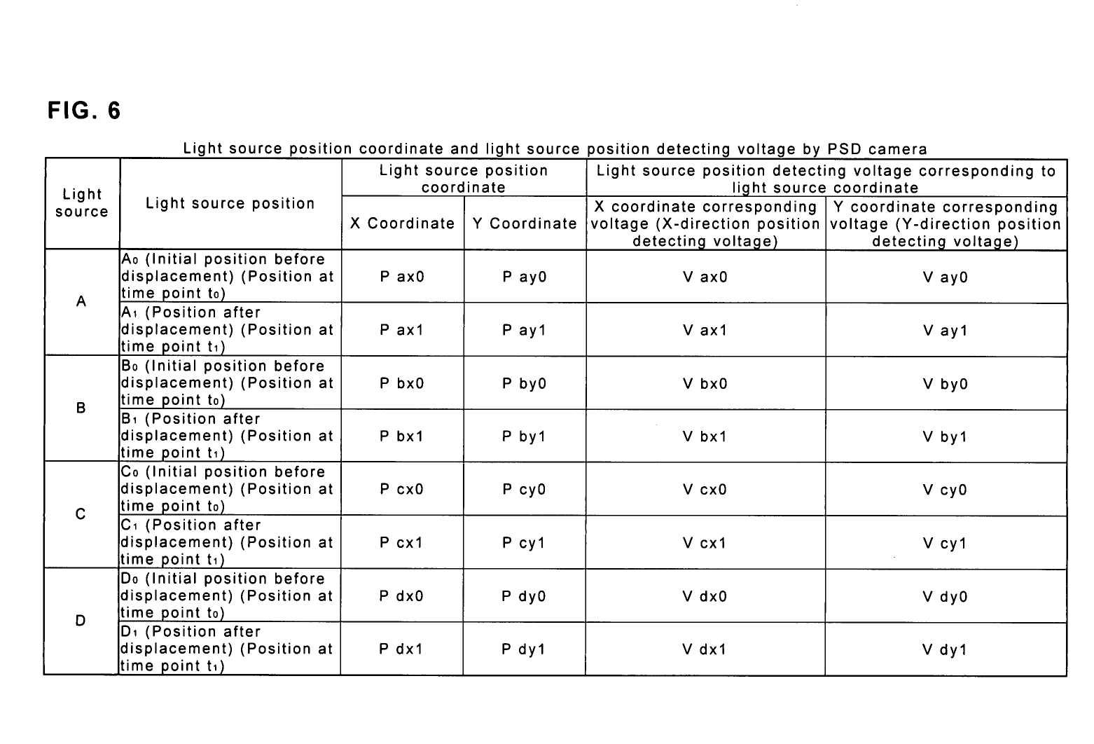

A description will be given below of an embodiment in accordance with this invention with reference to the accompanying drawings. FIG. 1 is an explanatory view of a basic structure of the displacement measuring apparatus in accordance with this invention. FIGS. 2(a) and 2(b) are plan views of the displacement measuring target used in the displacement measuring apparatus in accordance with this invention. FIG. 3 is an explanatory view of measurement of a two-dimensional parallel displacement by the displacement measuring method and apparatus in accordance with this invention. FIGS. 4(a) and 4(b) are explanatory views of measurement of a two-dimensional tilting displacement (rotational displacement) by the displacement measuring method and apparatus in accordance with this invention. FIGS. 5(a) and 5(b) are explanatory views of measurement of a three-dimensional displacement by the displacement measuring method and apparatus in accordance with this invention. FIG. 6 is a table comparing the relation between a light source position coordinate and a light source position detecting voltage by a PSD camera.

First, a description will be given of an embodiment of the displacement measuring target in accordance with this invention. FIG. 2(a) shows a surface of a displacement measuring target T (T1) which corresponds to one embodiment of the displacement measuring target in accordance with this invention and is suitable for measuring a two-dimensional displacement. The displacement measuring target T (T1) is structured by arranging and fixing two light sources (desirably constituted by infrared emitting diodes practically) A and D on a flat plate piece shaped substrate 1 so as to keep a predetermined X-direction interval Rx and a predetermined Y-direction interval Ry respectively in an X direction and a Y direction of rectangular X-Y coordinate axes. The predetermined X-direction interval Rx and the predetermined Y-direction interval Ry can be set to optional lengths in correspondence to conditions on design and manufacturing of the displacement measuring apparatus, however, in this embodiment, both the predetermined X-direction interval Rx and the predetermined Y-direction interval Ry are set to 10 mm as a matter of convenience. Further, the light sources A and D are firmly fixed onto the substrate 1 while keeping the predetermined intervals Rx and Ry in such a manner as to prevent the predetermined X-direction interval Rx and the predetermined Y-direction interval Ry from changing by accident during use.

Further, FIG. 2(b) shows another embodiment of the displacement measuring target in accordance with this invention, and shows a surface of a displacement measuring target T (T2) which is suitable for measuring a three-dimensional displacement. The displacement measuring target T (T2) is structured by arranging and fixing four light sources (desirably constituted by infrared emitting diodes practically) A, B, C and D on the flat plate piece shaped substrate 1, in such a manner that an X-direction interval between the light sources (between the light sources A and B and between the light sources C and D) which are adjacent in X direction of the rectangular X-Y coordinate axes, and a Y-direction interval between the light sources (between the light sources A and C and between the light sources B and D) which are adjacent in Y direction of the rectangular X-Y coordinate axes are firmly kept respectively to the predetermined X-direction interval Rx and the predetermined Y-direction interval Ry, that is, 10 mm. In this case, the predetermined interval mentioned above is not limited to 10 mm, but can be optionally set in correspondence to the conditions on design and manufacturing of the displacement measuring apparatus.

Next, a description will be given of an embodiment of the displacement measuring apparatus in accordance with this invention. FIG. 1 shows a basic structure of the displacement measuring apparatus in accordance with this invention. In FIG. 1, reference symbol W denotes various displacement measured subjects such as a house, a building, a road, a track, a tunnel, a bridge and the like, and reference symbol Ws denotes a measured point of the displacement measured subject W. At a time of measuring the displacement of the subject, the displacement measuring target T (T1 or T2) is attached to the measured point Ws of the displacement measured subject W. Reference numeral 2 denotes a PSD camera. The PSD cameral 2 is installed so as to be directed toward the displacement measuring target T (T1 or T2) fixed to the measured point Ws, at a displacement measured point which is away from the displacement measured subject W. Reference numeral 3 denotes a computer. The computer 3 is connected to an output terminal of the PSD camera 2. The PSD cameral 2 is provided with a lens 21 and a PSD light receiving surface 22 as a main portion, as is well known, and is provided with X-direction position detecting voltage output terminals 22x1 and 22x2 on the rectangular X-Y coordinate axes, and Y-direction position detecting voltage output terminals 22y1 and 22y2 on the rectangular X-Y coordinate axes, for outputting a position detecting voltage corresponding to a position of a light received by the PSD light receiving surface 22 to an external portion. Input signal terminals of the computer 3 is connected to the X-direction position detecting voltage output terminals 22x1 and 22x2 and the Y-direction position detecting voltage output terminals 22y1 and 22y2. Further, as is well known, in the PSD camera 2, the lights from the light sources A, B, C and D of the displacement measuring target T (T1 or T2) are focused and projected as a spot light through the lens 21 onto the PSD light receiving surface 22. Further, the X-direction position detecting voltage and the Y-direction position detecting voltage corresponding to the positions (the X coordinate and the Y coordinate) on the PSD light receiving surface 22 of the light received by the PSD light receiving surface 22 are respectively output between the X-direction position detecting voltage output terminals 22x1 and 22x2, and between the Y-direction position detecting voltage output terminals 22y1 and 22y2, and the computer 3 computes an amount of displacement of the measured point Ws of the displacement measured subject W on the basis of the X-direction position detecting voltage and the Y-direction position detecting voltage, whereby the amount of displacement of the measured point Ws of the displacement measured subject W is measured. In other words, the displacement measuring apparatus in accordance with this invention is structured such as to include the displacement measuring target, in which two or four light sources are arranged and fixed while keeping the predetermined X-direction interval and the predetermined Y-direction interval, the PSD camera provided with the lens and the PSD light receiving surface, and the computer computing the two-dimensional or three-dimensional amount of displacement of the measured point of the displacement measured subject on the base of the position detecting voltage of the light source output from the PSD camera.

Next, a description will be given of an embodiment of a displacement measuring method in accordance with this invention, that is, a method of measuring the amount of displacement of the displacement measured subject by using the displacement measuring apparatus mentioned above. The displacement measuring method in accordance with this invention is structured such as to seize an amount of displacement (displacement distance and length, and displacement angle) generated in the displacement measured subject as an amount of displacement of the light sources attached to the measured point of the displacement measured subject by the PSD camera, and is structured such as to seize the amount of displacement generated actually in the displacement measured subject as a distance or a length enlarged or contracted through the lens of the PSD camera on the PSD light receiving surface, generate the displacement detecting voltage corresponding to the distance or the length on the PSD light receiving surface by the PSD camera, and compute the amount of displacement generated actually in the displacement measured subject on the basis of the displacement detecting voltage so as to measure it. However, if a magnification of an optical system of the used PSD camera, or a distance between the lens of the PSD camera and the displacement measured subject at a time of measuring is different, even in the case that the amount of displacement generated in the displacement measured subject is identical, there is a risk that a difference is generated in the measured value with respect to the same amount of displacement generated in the displacement measured subject, and thus a real amount of displacement can not be accurately measured.

This invention provides the displacement measuring method to cope with such the great problem as mentioned above. A feature of the displacement measuring method in accordance with this invention makes it possible to accurately measure the amount of displacement generated actually in the displacement measured subject, by calculating and comprehending a rate between a predetermined distance or length on the displacement measured subject and the displacement detecting voltage output from the PSD camera in correspondence to the predetermined distance or length, in other words, a rate of the real distance or length on the actual displacement measured subject with respect to the displacement detecting voltage, that is, a displacement correction coefficient K, under a state in which a measuring environment such as the used PSD camera, the distance between the PSD camera and the displacement measured subject and the like is defined prior to measuring the amount of displacement of the displacement measured subject, and thereafter correcting the amount of displacement of the displacement measured subject measured via the PSD camera under the same measuring environment by using the displacement correction coefficient.

Next, a description will be given of an embodiment of the displacement measuring method in accordance with this invention with reference to FIGS. 1 to 4. This embodiment is structured such as to attach the displacement measuring target T1, in which two light sources A and D are arranged on the substrate 1, as shown in FIG. 2(a), or the displacement measuring target T2, in which four light sources A, B, C and Dare arranged on the substrate 1, as shown in FIG. 2(b), to the measured point Ws of the displacement measured subject W, seize the displacement generated in the measured point Ws of the subject Was the displacement of the light sources A, B, C and D by the PSD camera 2, and compute the displacement measured data by the computer 3 so as to measure the amount of displacement of the measured point Ws of the subject W.

FIG. 3 shows an example, in which the light sources A and D respectively move in parallel on an X-Y coordinate surface from positions A₀ and D₀ at a time point t₀ before displacement to positions A₁ and D₁ at a time point t₁ after displacement in consequence of displacement of the subject W, in the displacement measurement by using the displacement measuring target T1 in which two light sources A and D are arranged and fixed while keeping the predetermined X-direction interval Rx and the predetermined Y-direction interval Ry between the light sources, as shown in FIG. 2(a).

Further, FIGS. 4(a) and 4(b) show an example, in which the light sources A and D respectively move rotationally along an X-Y surface from positions A₀ and D₀ at a time point t₀ before displacement to positions A₁ and D₁ at a time point t₁ after displacement in consequence of displacement of the subject W, in the displacement measurement by using the displacement measuring target T2, in which four light sources A, B, C and D are arranged and fixed while keeping the predetermined X-direction interval Rx and the predetermined Y-direction interval Ry between the light sources, as shown in FIG. 2(b).

In the displacement measurement as mentioned above, measured data detected by the PSD camera 2 include a light source position coordinate data, a light source position detecting voltage data generated in correspondence to the light source position coordinate, and the like, as shown in FIG. 6, these measured data are adjusted by the displacement correction coefficient K such as the X-direction displacement correction coefficient Kx, the Y-direction displacement correction coefficient Ky, and the like, and the amount of displacement can be accurately computed and measured by the computer on the basis of these measured data.

Further, FIGS. 5(a) and 5(b) are drawings relating to a displacement in a three-dimensional direction including rectangular X-Y-Z axes. In other words, FIGS. 5(a) and 5(b) show an example in which the light sources A, B, C and D arranged and fixed to the X-Y coordinate surface are further displaced in a three-dimensional space. FIG. 5(a) shows a positional relation of each of the light sources, in which PDS camera 2 seizes the state that the light sources C and D are displaced in a backward direction of the paper surface around a line connecting the light sources A and B, and FIG. 5(b) shows a positional relation of each of the light sources in the case that the light sources B and C are displaced in a backward direction of the paper surface around a line connecting the light sources A and C. The positional relation of the light sources A, B, C and D seized by the PSD camera corresponds to a structural outline in well-known perspective. Then, it is possible to measure the three-dimensional amount of displacement of each of the light sources of the perspective structural outline in accordance with a well-known perspective analyzing means.

Needless to say, the displacement or fluctuation such as subsidence, protrusion, tilt, deformation, deflection, oscillation, and the like of a ground, a bank, a road, a track, a bridge, a tunnel, a building, and the like greatly relate to safety of a daily life environment, and the displacement measuring method and the displacement measuring apparatus in accordance with this invention are extremely useful for measuring and comprehending the displacement or fluctuation of these items. Accordingly, it is greatly expected to widely utilize the displacement measuring method and apparatus in accordance with this invention, in various manufacturing and service industries such as the civil engineering and construction industry, the real estate industry, the transport and transit industry, and the power and gas industry, which relate to maintenance and management of safely of the daily life environment.

What is claimed is:

1. A displacement measuring method that measuring is made by attaching a displacement measuring target structured such that two light sources, in which an X-direction interval and a Y-direction interval of rectangular X-Y coordinate axes are respectively kept at a predetermined X-direction interval (Sx) and a predetermined Y-direction interval (Sy), are arranged and fixed on a flat plate piece shaped substrate, to a measured point of a displacement measured subject, switching a lighting of each of said two light sources so as to focus and project a light from each of said light sources onto a PSD light receiving surface of a PSD camera through a lens of said PSD camera, thereby outputting an X-direction position detecting voltage and a Y-direction position detecting voltage respectively corresponding to positions on the PSD light receiving surfaces of said two light sources, calculating and comprehending a rate of said predetermined X-direction interval (Sx) with respect to a predetermined X-direction interval detecting voltage (Vsx) corresponding to said predetermined X-direction interval (Sx), that is, an X-direction displacement correction coefficient (Kx) and a rate of said predetermined Y-direction interval (Sy) with respect to a predetermined Y-direction interval detecting voltage (Vsy) corresponding to said predetermined Y-direction interval (Sy), that is, a Y-direction displacement correction coefficient (Ky) on the basis of said X-direction position detecting voltage, said Y-direction position detecting voltage, said predetermined X-direction interval (Sx) and said predetermined Y-direction interval (Sy), then measuring the X-direction position detecting voltage and the Y-direction position detecting voltage at an initial time point (t₀) before displacement of each of said two light sources on said displacement measured subject, and the X-direction position detecting voltage and the Y-direction position detecting voltage at a time point t₁ after displacement of each of said two light sources, and computing a two-dimensional amount of displacement of the measured point of said displacement measured subject on the basis of the X-direction position detecting voltage and the Y-direction position detecting voltage at the initial time point (t₀) before displacement of each of said two light sources, the X-direction position detecting voltage and the Y-direction position detecting voltage at the time point (t₁) after displacement, said X-direction displacement correction coefficient (Kx) and said Y-direction displacement correction coefficient (Ky).

2. A displacement measuring method that measuring is made by attaching a displacement measuring target structured such that four light sources, in which an X-direction interval between the light sources adjacent in an X direction of rectangular X-Y coordinate axes and a Y-direction interval between the light sources adjacent in a Y direction of said rectangular X-Y coordinate axes are respectively kept at a predetermined X-direction interval (Sx) and a predetermined Y-direction interval (Sy), are arranged and fixed on a flat plate piece shaped substrate, to a measured point of a displacement measured subject, switching lighting of each of said four light sources so as to focus and project a light from each of said light sources onto a PSD light receiving surface of a PSD camera through a lens of said PSD camera, thereby outputting an X-direction position detecting voltage and a Y-direction position detecting voltage respectively corresponding to positions on the PSD light receiving surfaces of said four light sources, calculating and comprehending a rate of said predetermined X-direction interval (Sx) with respect to a predetermined X-direction interval detecting voltage (Vsx) corresponding to said predetermined X-direction interval (Sx), that is, an X-direction displacement correction coefficient (Kx) and a rate of said predetermined Y-direction interval (Sy) with respect to a predetermined Y-direction interval detecting voltage (Vsy) corresponding to said predetermined Y-direction interval (Sy), that is, a Y-direction displacement correction coefficient (Ky) on the basis of said X-direction position detecting voltage, said Y-direction position detecting voltage, said predetermined X-direction interval (Sx) and said predetermined Y-direction interval (Sy), then measuring the X-direction position detecting voltage and the Y-direction position detecting voltage at an initial time point (t₀) before displacement of each of said four light sources on said displacement measured subject, and the X-direction position detecting voltage and the Y-direction position detecting voltage at a time point (t₁) after displacement of each of said four light sources, and computing a two-dimensional and/or three-dimensional amount of displacement of the measured point of said displacement measured subject on the basis of the X-direction position detecting voltage and the Y-direction position detecting voltage at the initial time point (t₀) before displacement of each of said four light sources, the X-direction position detecting voltage and the Y-direction position detecting voltage at the time point (t₁) after displacement, said X-direction displacement correction coefficient (Kx), and said Y-direction displacement correction coefficient (Ky).

3. A displacement measuring apparatus comprising:
a displacement measuring target structured such that two light sources, in which an X-direction interval and a Y-direction interval of rectangular X-Y coordinate axes are respectively kept at a predetermined X-direction interval (Sx) and a predetermined Y-direction interval (Sy), are arranged and fixed on a flat plate piece shaped substrate attached to a measured point of a displacement measured subject;
a PSD camera provided with a lens and a PSD light receiving surface, and outputting an X-direction position detecting voltage and a Y-direction position detecting voltage corresponding to positions on said PSD light receiving surface of said two light sources on the basis of a sequential focusing and projection of a light from each of said two light sources onto said PSD light receiving surface through the lens; and
a computer computing and outputting a two-dimensional amount of displacement of a measured point of said displacement measured subject on the basis of a rate of said predetermined X-direction interval (Sx) with respect to a predetermined X-direction interval detecting voltage (Vsx) corresponding to said predetermined X-direction interval (Sx), that is, an X-direction displacement correction coefficient (Kx) and a rate of said predetermined Y-direction interval (Sy) with respect to a predetermined Y-direction interval detecting voltage (Vsy) corresponding to said predetermined Y-direction interval (Sy), that is, a Y-direction displacement correction coefficient (Ky) which are calculated on the basis of said X-direction position detecting voltage, said Y-direction position detecting voltage, said predetermined X-direction interval (Sx) and said predetermined Y-direction interval (Sy), and the X-direction position detecting voltage and the Y-direction position detecting voltage at an initial time point (t₀) before displacement of said two light sources on said displacement measured subject, and the X-direction position detecting voltage and the Y-direction position detecting voltage at a time point (t₁) after displacement of said two light sources on said displacement measured subject, and said X-direction displacement correction coefficient (Kx) and said Y-direction displacement correction coefficient (Ky).

4. A displacement measuring apparatus comprising:
a displacement measuring target structured such that four light sources, in which an X-direction interval between the light sources adjacent in an X direction of rectangular X-Y coordinate axes and a Y-direction interval between the light sources adjacent in a Y direction of said rectangular X-Y coordinate axes are respectively kept at a predetermined X-direction interval (Sx) and a predetermined Y-direction interval (Sy), are arranged and fixed on a flat plate piece shaped substrate attached to a measured point of a displacement measured subject;
a PSD camera provided with a lens and a PSD light receiving surface, and outputting an X-direction position detecting voltage and a Y-direction position detecting voltage corresponding to positions on said PSD light receiving surface of said four light sources on the basis of a sequential focusing and projection of a light from each of said four light sources onto said PSD light receiving surface through the lens; and
a computer computing and outputting a two-dimensional and/or three-dimensional amount of displacement of a measured point of said displacement measured subject on the basis of a rate of said predetermined X-direction interval (Sx) with respect to a predetermined X-direction interval detecting voltage (Vsx) corresponding to said predetermined X-direction interval (Sx), that is, an X-direction displacement correction coefficient (Kx) and a rate of said predetermined Y-direction interval (Sy) with respect to a predetermined Y-direction interval detecting voltage (Vsy) corresponding to said predetermined Y-direction interval (Sy), that is, a Y-direction displacement correction coefficient (Ky), which are calculated on the basis of said X-direction position detecting voltage, said Y-direction position detecting voltage, said predetermined X-direction interval (Sx) and said predetermined Y-direction interval (Sy), and the X-direction position detecting voltage and the Y-direction position detecting voltage at an initial time point (t₀) before displacement of said four light sources on said displacement measured subject, and the X-direction position detecting voltage and the Y-direction position detecting voltage at a time point (t₁) after displacement of said four light sources on said displacement measured subject, and said X-direction displacement correction coefficient (Kx) and said Y-direction displacement correction coefficient (Ky).

5. A displacement measuring target in which two light sources structured such that an X-direction interval and a Y-direction interval of rectangular X-Y coordinate axes are kept respectively at a predetermined X-direction interval and a predetermined Y-direction interval, are arranged and fixed on a flat plate piece shaped substrate attached to a measured point of a displacement measured subject.

6. A displacement measuring target in which four light sources structured such that an interval between the light sources adjacent in an X direction of rectangular X-Y coordinate axes and an interval between the light sources adjacent in a Y direction of the rectangular X-Y coordinate axes are kept respectively at a predetermined X-direction interval and a predetermined Y-direction interval, are arranged and fixed on a flat plate piece shaped substrate attached to a measured point of a displacement measured subject.
